(19) United States
(12) Patent Application Publication
(10) Pub. No.: US 2026/0077385 A1
(43) Pub. Date: Mar. 19, 2026

(54) FILM FORMING METHOD, CURABLE COMPOSITION, AND ARTICLE MANUFACTURING METHOD

(71) Applicant: CANON KABUSHIKI KAISHA, Tokyo (JP)

(72) Inventors: JUMPEI SHIRONO, Kanagawa (JP); HINAKO MATSUSHIMA, Tochigi (JP); TOSHIKI ITO, Kanagawa (JP)

(21) Appl. No.: 19/330,928

(22) Filed: Sep. 17, 2025

(30) Foreign Application Priority Data
Sep. 19, 2024 (JP) 2024-162452

(51) Int. Cl. B05D 1/00; B05D 3/06; B05D 3/12

(52) U.S. Cl. CPC B05D 1/005; B05D 3/067; B05D 3/12; B05D 2518/00

(57) ABSTRACT

A film forming method including arranging a curable composition containing a polymerizable compound and a solvent on a substrate using a spin coating method, and planarizing the curable composition arranged on the substrate to form a film, wherein a viscosity μ [mPa·s] of a composition obtained by removing the solvent from the curable composition is smaller than a value of a function f determined by a period λ [μm] of a concave-convex shape of the substrate and a thickness d_{f} [nm] of the curable composition after curing.

### BACKGROUND

### Field of the Technology

The present disclosure relates to a film forming method, a curable composition, and an article manufacturing method.

### Description of the Related Art

A photolithography step of fabricating a device such as a semiconductor element requires planarization of the surface (base) of a substrate. For example, in an extreme ultraviolet exposure technique (EUV) that is one of photolithography techniques attracting attention in recent years, the depth of focus at which a projected image is formed decreases as miniaturization advances, so the unevenness on the surface of a substrate to which a resist is supplied must be decreased to a few nm or less.

As one of planarization techniques for planarizing the surface of a substrate, a technique of performing planarization by forming an underlayer film on a substrate (planarization target substrate) with unevenness on the surface is proposed in literature 1 below.

Literature 1: T. Endo, R. Sakamoto, et. al, “Novel Spin on Planarization Technology by Photo Curing SOC”, Journal of Photopolymer Science and Technology Volume 30, Number 3 (2017) 373-378.

In the technique disclosed in literature 1, the underlayer film is formed using a spin coating method. However, it is impossible to obtain sufficient flatness only by the spin coating method. Hence, the viscosity is lowered by heating a composition that forms the underlayer film, and the flowability is promoted, thereby forming a flatter film.

### SUMMARY

The present disclosure provides a new technique concerning formation of a film of a curable composition.

According to one aspect of the present disclosure, there is provided a film forming method including arranging a curable composition containing a polymerizable compound and a solvent on a substrate using a spin coating method, and planarizing the curable composition arranged on the substrate to form a film, wherein a viscosity μ [mPa·s] of a composition obtained by removing the solvent from the curable composition is smaller than a value of a function f

$$f ( λ , {d}_{f} ) = 4.3 \times {10}^{6} \times {λ}^{- 4} \times {( \frac{{d}_{f}}{15} )}^{2.7}$$

determined by a period λ [μm] of a concave-convex shape of the substrate and a thickness d_{f} [nm] of the curable composition after curing.

Features of the present disclosure will become apparent from the following description of embodiments with reference to the attached drawings. The following description of embodiments are described by way of example.

### BRIEF DESCRIPTION OF THE DRAWINGS

FIGS. 1A to 1D are views for explaining a film forming method according to one aspect of the present disclosure.

FIG. 2 is a view showing a state in which an underlayer film formation composition is planarized.

FIG. 3 is a graph showing an example of the relationship between the concave-convex shape of a substrate and an initial liquid film distribution.

FIG. 4 is a graph showing the time-rate change of the liquid film distribution of a curable composition.

FIG. 5 is a graph showing the time-rate change of the height difference of the liquid film distribution of the curable composition.

FIG. 6 is a graph showing time required for a planarization step when the viscosity of the curable composition is changed.

FIG. 7 is a graph showing a result of calculating the upper limit value of the viscosity of the curable composition that was planarized in 200 sec while variously changing the period of the concave-convex shape of the substrate.

FIG. 8 is a graph showing a result of calculating time required for the planarization step while variously changing the thickness of the thinnest portion of the underlayer film.

### DESCRIPTION OF THE EMBODIMENTS

Hereinafter, embodiments will be described in detail with reference to the attached drawings. Note, the following embodiments are not intended to limit the scope of the claims. Multiple features are described in the embodiments, but it is not the case that all such features are required, and multiple such features may be combined as appropriate. Furthermore, in the attached drawings, the same reference numerals are given to the same or similar configurations, and redundant description thereof is omitted.

In providing a new technique concerning formation of a film of a curable composition, the present inventors found a film forming method capable of forming a film of a curable composition having a high flatness at about room temperature (for example, 23° C.).

### [Curable Composition (A)]

A curable composition (A) according to the present disclosure is an underlayer film composition. The curable composition (A) is a composition containing (a component (a) that is) a polymerizable compound (a) having polymerizability, and (a component (d) that is) a solvent (d). The curable composition (A) may further contain at least one of (a component (b) that is) a polymerization initiator and (a component (c) that is) a nonpolymerizable compound (c).

<Polymerizable Compound (a)>

In the present disclosure, the polymerizable compound (a) is a compound that reacts with a polymerizing factor (a radical or a cation) generated from the polymerization initiator (b) and forms a film made of a polymer compound by a chain reaction (polymerization reaction).

Examples of the polymerizable compound (a) are a radical polymerizable compound and a cation polymerizable compound. The polymerizable compound (a) can be formed by only one type of polymerizable compound, and can also be formed by a plurality of types (one or more types) of polymerizable compounds.

The polymerizable compound (a) according to the present disclosure contains at least a compound (a-1) containing one or more aromatic rings or aromatic heterocycles and two or more vinyl groups directly combining with the aromatic rings or aromatic heterocycles.

<Compound (a-1): Polymerizable Compound>

Practical examples of the compound (a-1) are as follows, but the compound (a-1) is not limited to these examples.

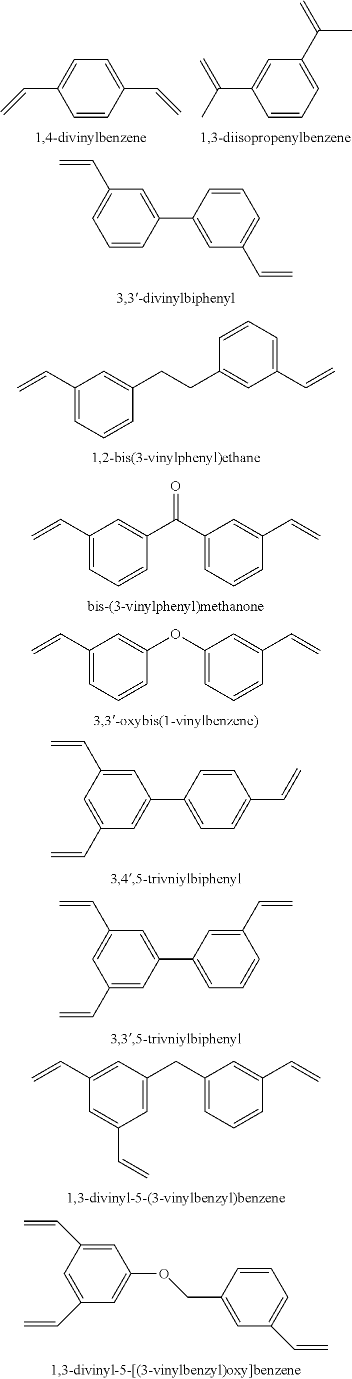

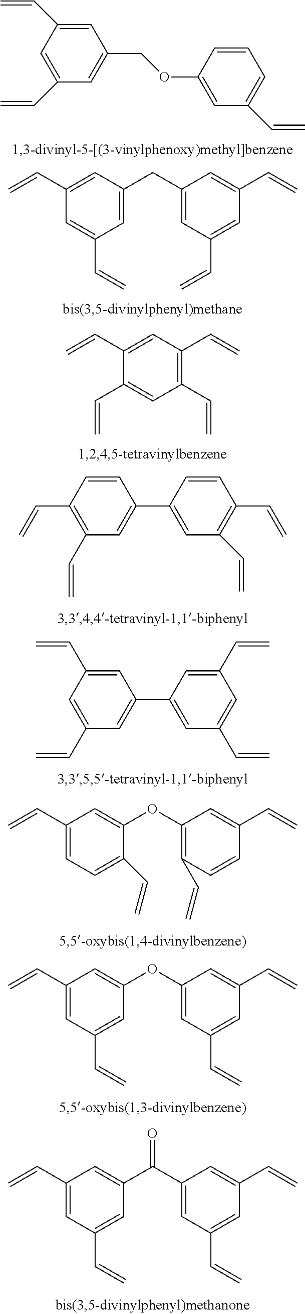

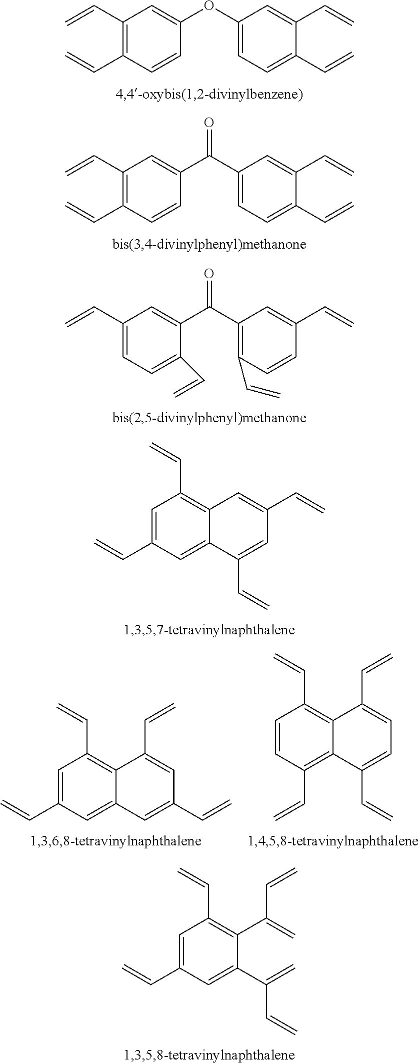

The polymerizable compound (a) may contain a compound (a-2) that is not the compound (a-1) containing one or more aromatic rings or aromatic heterocycles and two or more vinyl groups directly combining with the aromatic rings or aromatic heterocycles. Examples of the compound (a-2) are a (meth)acrylic compound, a styrene-based compound, a vinyl-based compound, an allylic compound, a fumaric compound, and a maleic compound, which are radical polymerizable compounds.

The (meth)acrylic compound is a compound having one or more acryloyl groups or methacryloyl groups. Examples of a monofunctional (meth)acrylic compound having one acryloyl group or methacryloyl group are as follows, but the compound is not limited to these examples.

Phenoxyethyl (meth)acrylate, phenoxy-2-methylethyl (meth)acrylate, phenoxyethoxyethyl (meth)acrylate, 3-phenoxy-2-hydroxypropyl (meth)acrylate, 2-phenylphenoxyethyl (meth)acrylate, 4-phenylphenoxyethyl (meth)acrylate, 3-(2-phenylphenyl)-2-hydroxypropyl (meth)acrylate, (meth)acrylate of EO-modified p-cumylphenol, 2-bromophenoxyethyl (meth)acrylate, 2,4-dibromophenoxyethyl (meth)acrylate, 2,4,6-tribromophenoxyethyl (meth)acrylate, EO-modified phenoxy (meth)acrylate, PO-modified phenoxy (meth)acrylate, polyoxyethylenenonylphenylether (meth)acrylate, isobornyl (meth)acrylate, 1-adamantyl (meth)acrylate, 2-methyl-2-adamantyl (meth)acrylate, 2-ethyl-2-adamantyl (meth)acrylate, bornyl (meth)acrylate, tricyclodecanyl (meth)acrylate, dicyclopentanyl (meth)acrylate, dicyclopentenyl (meth)acrylate, cyclohexyl (meth)acrylate, 4-butylcyclohexyl(meth)acrylate, acryloylmorpholine, 2-hydroxyethyl (meth)acrylate, 2-hydroxypropyl (meth)acrylate, 2-hydroxybutyl (meth)acrylate, methyl (meth)acrylate, ethyl (meth)acrylate, propyl (meth)acrylate, isopropyl (meth)acrylate, butyl (meth)acrylate, amyl (meth)acrylate, isobutyl (meth)acrylate, t-butyl (meth)acrylate, pentyl (meth)acrylate, isoamyl (meth)acrylate, hexyl (meth)acrylate, heptyl (meth)acrylate, octyl (meth)acrylate, isooctyl (meth)acrylate, 2-ethylhexyl (meth)acrylate, nonyl (meth)acrylate, decyl (meth)acrylate, isodecyl (meth)acrylate, undecyl (meth)acrylate, dodecyl (meth)acrylate, lauryl (meth)acrylate, stearyl (meth)acrylate, isostearyl (meth)acrylate, benzyl (meth)acrylate, tetrahydrofurfuryl (meth)acrylate, butoxyethyl (meth)acrylate, ethoxydiethyleneglycol (meth)acrylate, polyethyleneglycol mono(meth)acrylate, polypropyleneglycol mono(meth)acrylate, methoxyethyleneglycol (meth)acrylate, ethoxyethyl (meth)acrylate, methoxypolyethyleneglycol (meth)acrylate, methoxypolypropyleneglycol (meth)acrylate, diacetone (meth)acrylamide, isobutoxymethyl (meth)acrylamide, N,N-dimethyl (meth)acrylamide, t-octyl (meth)acrylamide, dimethylaminoethyl (meth)acrylate, diethylaminoethyl (meth)acrylate, 7-amino-3,7-dimethyloctyl (meth)acrylate, N,N-diethyl (meth)acrylamide, N,N-dimethylaminopropyl (meth)acrylamide, 1- or 2-naphthyl (meth)acrylate, 1- or 2-naphthylmethyl (meth)acrylate, 3- or 4-phenoxybenzyl (meth)acrylate, and cyanobenzyl (meth)acrylate.

Examples of the commercially available products of the above-described monofunctional (meth)acrylic compounds are as follows, but the products are not limited to these examples.

ARONIX® M101, M102, M110, M111, M113, M117, M5700, TO-1317, M120, M150, and M156 (manufactured by TOAGOSEI),
MEDOL10, MIBDOL10, CHDOL10, MMDOL30, MEDOL30, MIBDOL30, CHDOL30, LA, IBXA, 2-MTA, HPA, and Viscoat #150, #155, #158, #190, #192, #193, #220, #2000, #2100, and #2150 (manufactured by OSAKA ORGANIC CHEMICAL INDUSTRY), Light Acrylate BO-A, EC-A, DMP-A, THF-A, HOP-A, HOA-MPE, HOA-MPL, PO-A, P-200A, NP-4EA, NP-8EA, Epoxy Ester M-600A, POB-A, and OPP-EA (manufactured by KYOEISHA CHEMICAL),
KAYARAD® TC110S, R-564, and R-128H (manufactured by NIPPON KAYAKU), NK Ester AMP-10G, AMP-20G, and A-LEN-10 (manufactured by SHIN-NAKAMURA CHEMICAL),
FA-511A, 512A, and 513A (manufactured by Hitachi Chemical), PHE, CEA, PHE-2, PHE-4, BR-31, BR-31M, and BR-32 (manufactured by DKS), VP (manufactured by BASF), and
ACMO, DMAA, and DMAPAA (manufactured by Kohjin).

Examples of a polyfunctional (meth)acrylic compound having two or more acryloyl groups or methacryloyl groups are as follows, but the compound is not limited to these examples.

Trimethylolpropane di(meth)acrylate, trimethylolpropane tri(meth)acrylate, EO-modified trimethylolpropane tri(meth)acrylate, PO-modified trimethylolpropane tri(meth)acrylate, EO- and PO-modified trimethylolpropane tri(meth)acrylate, dimethylol tricyclodecane di(meth)acrylate, pentaerythritol tri(meth)acrylate, pentaerythritol tetra(meth)acrylate, ethylene glycol di(meth)acrylate, tetraethylene glycol di(meth)acrylate, polyethylene glycol di(meth)acrylate, polypropylene glycol di(meth)acrylate, 1,4-butanediol di(meth)acrylate, 1,6-hexanediol di(meth)acrylate, neopentyl glycol di(meth)acrylate, 1,9-nonanediol di(meth)acrylate, 1,10-decanediol di(meth)acrylate, 1,3-adamantanedimethanol di(meth)acrylate, tris(2-hydoxyethyl)isocyanurate tri(meth)acrylate, tris(acryloyloxy)isocyanurate, bis(hydroxymethyl)tricyclodecane di(meth)acrylate, dipentaerythritol penta(meth)acrylate, dipentaerythritol hexa(meth)acrylate, EO-modified 2,2-bis(4-((meth)acryloxy)phenyl)propane, PO-modified 2,2-bis(4-((meth)acryloxy)phenyl)propane, EO- and PO-modified 2,2-bis(4-((meth)acryloxy)phenyl)propane, o-, m-, or p-benzene di(meth)acrylate, and o-, m-, or p-xylylene di(meth)acrylate.

Examples of the commercially available products of the above-described polyfunctional (meth)acrylic compounds are as follows, but the products are not limited to these examples.

Yupimer® UV SA1002 and SA2007 (manufactured by Mitsubishi Chemical), Viscoat #195, #230, #215, #260, #335HP, #295, #300, #360, #700, GPT, and 3PA (manufactured by OSAKA ORGANIC CHEMICAL INDUSTRY),
Light Acrylate 4EG-A, 9EG-A, NP-A, DCP-A, BP-4EA, BP-4PA, TMP-A, PE-3A, PE-4A, and DPE-6A (manufactured by KYOEISHA CHEMICAL),
KAYARAD® PET-30, TMPTA, R-604, DPHA, DPCA-20, -30, -60, and -120, HX-620, D-310, and D-330 (manufactured by NIPPON KAYAKU),
ARONIX® M208, M210, M215, M220, M240, M305, M309, M310, M315, M325, and M400 (manufactured by TOAGOSEI),
Ripoxy® VR-77, VR-60, and VR-90 (manufactured by Showa Highpolymer),
OGSOL EA-0200 and OGSOL EA-0300 (manufactured by Osaka Gas Chemicals).

Note that in the above-described compound county, (meth)acrylate means acrylate or methacrylate having an alcohol residue equal to acrylate. A (meth)acryloyl group means an acryloyl group or a methacryloyl group having an alcohol residue equal to the acryloyl group. EO indicates ethylene oxide, and an EO-modified compound A indicates a compound in which a (meth)acrylic acid residue and an alcohol residue of a compound A bond via the block structure of an ethylene oxide group. Also, PO indicates a propylene oxide, and a PO-modified compound B indicates a compound in which a (meth)acrylic acid residue and an alcohol residue of a compound B bond via the block structure of a propylene oxide group.

Practical examples of the styrene-based compound are as follows, but the compound is not limited to these examples.

Alkylstyrene such as styrene, 2,4-dimethyl-α-methylstyrene, o-methylstyrene, m-methylstyrene, p-methylstyrene, 2,4-dimethylstyrene, 2,5-dimethylstyrene, 2,6-dimethylstyrene, 3,4-dimethylstyrene, 3,5-dimethylstyrene, 2,4,6-trimethylstyrene, 2,4,5-trimethylstyrene, pentamethylstyrene, o-ethylstyrene, m-ethylstyrene, p-ethylstyrene, diethylstyrene, triethylstyrene, propylstyrene 2,4-diisopropylstyrene, butylstyrene, hexylstyrene, heptylstyrene, and octylstyrene; styrene halide such as fluorostyrene, o-chlorostyrene, m-chlorostyrene, p-chlorostyrene, o-bromostyrene, m-bromostyrene, p-bromostyrene, dibromostyrene, and iodostyrene; and a compound having a styryl group as a polymerizable functional group, such as nitrostyrene, acetylstyrene, o-methoxystyrene, m-methoxystyrene, p-methoxystyrene, o-hydroxystyrene, m-hydroxystyrene, p-hydroxystyrene, 2-vinylbiphenyl, 3-vinylbiphenyl, 4-vinylbiphenyl, 1-vinylnaphthalene, 2-vinylnaphthalene, 4-vinyl-p-terphenyl, 1-vinylanthracene, α-methylstyrene, o-isopropenyltoluene, m-isopropenyltoluene, p-isopropenyltoluene, 2,3-dimethyl-α-methylstyrene, 3,5-dimethyl-α-methylstyrene, p-isopropyl-α-methylstyrene, α-ethylstyrene, α-chlorostyrene, divinylbenzene, diisopropylbenzene, and divinylbiphenyl.

Practical examples of the vinyl-based compound are as follows, but the compound is not limited to these examples.

Vinylpyridine, vinylpyrrolidone, vinylcarbazole, vinyl acetate, and acrylonitrile; conjugated diene monomers such as butadiene, isoprene, and chloroprene; vinyl halide such as vinyl chloride and vinyl bromide; a compound having a vinyl group as a polymerizable functional group, for example, vinylidene halide such as vinylidene chloride, vinyl ester of organic carboxylic acid and its derivative (for example, vinyl acetate, vinyl propionate, vinyl butyrate, vinyl benzoate, and divinyl adipate), and (meth)acrylonitrile.

Note that in this specification, (meth)acrylonitrile is a general term for acrylonitrile and methacrylonitrile.

Examples of the allylic compound are as follows, but the compound is not limited to these examples.

Allyl acetate, allyl benzoate, diallyl adipate, diallyl terephthalate, diallyl isophthalate, and diallyl phthalate.

Examples of the fumaric compound are as follows, but the compound is not limited to these examples.

Dimethyl fumarate, diethyl fumarate, diisopropyl fumarate, di-sec-butyl fumarate, diisobutyl fumarate, di-n-butyl fumarate, di-2-ethylhexyl fumarate, and dibenzyl fumarate.

Examples of the maleic compound are as follows, but the compound is not limited to these examples.

Dimethyl maleate, diethyl maleate, diisopropyl maleate, di-sec-butyl maleate, diisobutyl maleate, di-n-butyl maleate, di-2-ethylhexyl maleate, and dibenzyl maleate.

Other examples of the radical polymerizable compound are as follows, but the compound is not limited to these examples.

Dialkylester of itaconic acid and its derivative (for example, dimethyl itaconate, diethyl itaconate, diisopropyl itaconate, di-sec-butyl itaconate, diisobutyl itaconate, di-n-butyl itaconate, di-2-ethylhexyl itaconate, and dibenzyl itaconate), an N-vinylamide derivative of organic carboxylic acid (for example, N-methyl-N-vinylacetamide), and maleimide and its derivative (for example, N-phenylmaleimide and N-cyclohexylmaleimide).

When the polymerizable compound (a) is formed by a plurality of types of polymerizable compounds, the ratio of the compound (a-1) to the polymerizable compound (a) is preferably 20 wt % or more, more preferably 50 wt % or more, and further preferably 90 wt % or more. This is because the higher the ratio of the compound (a-1) to the polymerizable compound (a) is, the higher the heat resistance is.

<Ohnishi Parameter of Polymerizable Compound (a)>

It is known that a dry etching rate V of an organic compound, a number N of all atoms in the organic compound, a number N_{C} of all carbon atoms in a composition, and a number N_{O} of all oxygen atoms in the composition have a relationship of equation (1) below (see literature A).

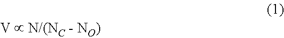

Literature A: Proc. SPIE 11324-11 (2020)

Here, N/(N_{C}−N_{O}) is also called “Ohnishi Parameter” (to be referred to as “OP” hereinafter). For example, there is known a technique of obtaining a photocurable composition having a high dry etching resistance by using a polymerizable compound having a small OP.

Equation (1) indicates that an organic compound having many oxygen atoms in a molecule or having few aromatic ring structures or alicyclic structures has a large OP and a high dry etching rate.

In the curable composition (A) according to the present disclosure, the OP of the polymerizable compound (a) is preferably 1.80 or more and 2.70 or less, more preferably 2.00 or more and 2.60 or less, and further preferably 2.30 or more and 2.60 or less. When the OP of the polymerizable compound (a) is 2.70 or less, the cured film of the curable composition (A) has a high dry etching resistance. Also, when the OP of the polymerizable compound (a) is 1.80 or more, the cured film of the curable composition (A) can easily be removed when the underlayer is processed by using the cured film of the curable composition (A). When the polymerizable compound (a) is formed by a plurality of types polymerizable compounds (components) a₁, a₂, . . . , aₙ, the OP is calculated as a weighted average value (molar fraction weighted average value) based on the molar fraction as indicated by equation (2) below. If the polymerizable compound (a) contains one or more types of polymerizable compounds, the OP of the polymerizable compound (a) is calculated as the molar fraction weighted average value of an N/(N_{c}−Nₒ) value of each molecule of the one or more types of polymerizable compounds.

$$OP = {\sum }_{i = n} {n}_{i} {OP}_{i} = {n}_{1} {OP}_{1} + {n}_{2} {OP}_{2} + … + {n}_{n} {OP}_{n} \qquad ( 2 )$$

where OPₙ is the OP of the component aₙ, and nₙ is the molar fraction occupied by the component aₙ in the entire polymerizable compound (a).

In the film (underlayer film) forming method according to the present disclosure, in a planarization step, the curable composition (A) arranged as an underlayer film formation composition on the substrate as the planarization target, that is, the substrate (base) having an concave-convex shape (concave-convex pattern) is planarized. In this planarization step, the solvent (d) is volatilized, but the polymerizable compound (a) must not be volatilized. Accordingly, the boiling points of one or more types of polymerizable compounds included in the polymerizable compound (a) at normal pressure are preferably 250° C. or more, more preferably 300° C. or more, and further preferably 350° C. or more. Also, to obtain a high dry etching resistance and a high heat resistance, the cured film of the curable composition (A) preferably contains at least a compound having a cyclic structure such as an aromatic structure, an aromatic heterocyclic structure, or an alicyclic structure. Note that the normal pressure is 1 atm (atmospheric pressure).

The boiling point of the polymerizable compound (a) is almost correlated with the molecular weight. Therefore, the molecular weights of one or more types of polymerizable compounds included in the polymerizable compound (a) are preferably 200 or more, more preferably 240 or more, and further preferably 300 or more. That is, the lower limit of the molecular weight of the polymerizable functional group in the polymerizable compound (a) is 200 or more. However, even when the molecular weight is 200 or less, the compound is preferably usable as the polymerizable compound (a) of the present disclosure if the boiling point is 250° C. or more.

In addition, the vapor pressure at 80° C. of the polymerizable compound (a) is preferably 0.001 mmHg or less. This is so because in a heating step for accelerating volatilization of the solvent (d) (to be described later) or in heating during a curing step of a curable composition obtained by removing the solvent (d) from the curable composition (A), it is necessary to suppress volatilization of the polymerizable compound (a).

Note that the boiling point and the vapor pressure of each of various kinds of organic compounds at normal pressure can be calculated by, for example, Hansen Solubility Parameters in Practice (HSPiP) 5th Edition. 5.3.04.

Practical examples of the polymerizable compound (a) having a boiling point of 250° C. or more are as follows, but the compound is not limited to these examples.
dicyclopentanyl acrylate (boiling point=262° C., molecular weight=206)
dicyclopentenyl acrylate (boiling point=270° C., molecular weight=204)
1,3-cyclohexanedimethanol diacrylate (boiling point=310° C., molecular weight=252)
1,4-cyclohexanedimethanol diacrylate (boiling point=339° C., molecular weight=252)
4-hexylresorcinol diacrylate (boiling point=379° C., molecular weight=302)
6-phenylhexane-1,2-diol diacrylate (boiling point=381° C., molecular weight=302)
7-phenylheptan-1,2-diol diacrylate (boiling point=393° C., molecular weight=316)
1,3-bis((2-hydroxyethoxy)methyl)cyclohexane diacrylate (boiling point=403° C., molecular weight=340)
8-phenyloctane-1,2-diol diacrylate (boiling point=404° C., molecular weight=330)
1,3-bis((2-hydroxyethoxy)methyl)benzene diacrylate (boiling point=408° C., molecular weight=334)
1,4-bis((2-hydroxyethoxy)methyl)cyclohexane diacrylate (boiling point=445° C., molecular weight=340)
3-phenoxybenzyl acrylate (mPhOBzA, OP=2.54, boiling point=367.4° C., 80° C. vapor pressure=0.0004 mmHg, molecular weight=254.3)

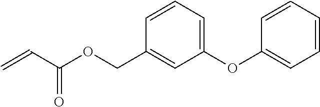 [SMILES: C=CC(=O)OCc1cccc(Oc2ccccc2)c1]

1-naphthyl acrylate (NaA, OP=2.27, boiling point=317° C., 80° C. vapor pressure=0.0422 mmHg, molecular weight=198)

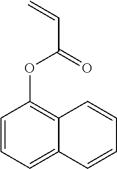

2-phenylphenoxyethyl acrylate (PhPhOEA, OP=2.57, boiling point=364.2° C., 80° C. vapor pressure=0.0006 mmHg, molecular weight=268.3)

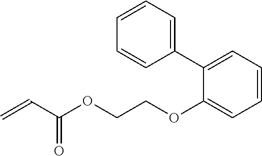 [SMILES: C=CC(=O)OCCOc1ccccc1-c1ccccc1]

1-naphthylmethyl acrylate (NalMA, OP=2.33, boiling point=342.1° C., 80° C. vapor pressure=0.042 mmHg, molecular weight=212.2)

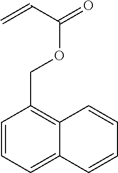 [SMILES: C=CC(=O)OCc1cccc2ccccc12]

2-naphthylmethyl acrylate (Na2MA, OP=2.33, boiling point=342.1° C., 80° C. vapor pressure=0.042 mmHg, molecular weight=212.2)

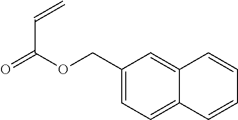 [SMILES: C=CC(=O)OCc1ccc2ccccc2c1]

4-cyanobenzyl acrylate (CNBzA, OP=2.44, boiling point=316° C., molecular weight=187)

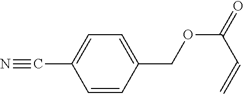

DVBzA indicated by the formula below (OP=2.50, boiling point=304.6° C., 80° C. vapor pressure=0.0848 mmHg, molecular weight=214.3)

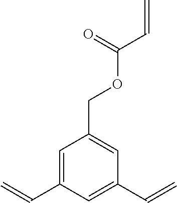 [SMILES: C=CC(=O)OCc1cc(C=C)cc(C=C)c1]

DPhPA indicated by the formula below (OP=2.38, boiling point=354.5° C., 80° C. vapor pressure=0.0022 mmHg, molecular weight=266.3)

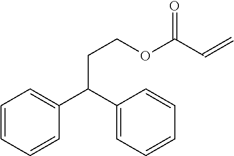 [SMILES: C=CC(=O)OCCC(c1ccccc1)c1ccccc1]

PhBzA indicated by the formula below (OP=2.29, boiling point=350.4° C., 80° C. vapor pressure=0.0022 mmHg, molecular weight=238.3)

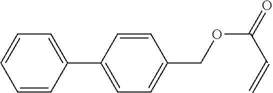 [SMILES: C=CC(=O)OCc1ccc(-c2ccccc2)cc1]

FLMA indicated by the formula below (OP=2.20, boiling point=349.3° C., 80° C. vapor pressure=0.0018 mmHg, molecular weight=250.3)

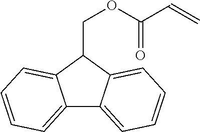 [SMILES: C=CC(=O)OCC1c2ccccc2-c2ccccc21]

ATMA indicated by the formula below (OP=2.13, boiling point=414.9° C., 80° C. vapor pressure=0.0001 mmHg, molecular weight=262.3)

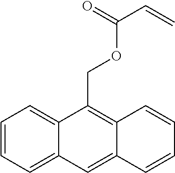 [SMILES: C=CC(=O)OCc1c2ccccc2cc2ccccc12]

DNaMA indicated by the formula below (OP=2.00, boiling point=489.4° C., 80° C. vapor pressure<0.0001 mmHg, molecular weight=338.4)

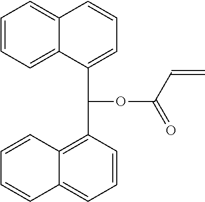 [SMILES: C=CC(=O)OC(c1cccc2ccccc12)c1cccc2ccccc12]

tricyclodecanedimethanol diacrylate (DCPDA, OP=3.29, boiling point=342° C., 80° C. vapor pressure<0.0024 mmHg, molecular weight=304)

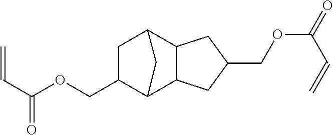 [SMILES: C=CC(=O)OCC1CC2C3CC(COC(=O)C=C)C(C3)C2C1]

m-xylylene diacrylate (mXDA, OP=3.20, boiling point=336° C., 80° C. vapor pressure<0.0043 mmHg, molecular weight=246)

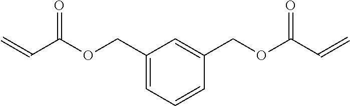 [SMILES: C=CC(=O)OCc1cccc(COC(=O)C=C)c1]

1-phenylethane-1,2-diyl diacrylate (PhEDA, OP=3.20, 80° C. vapor pressure<0.0057 mmHg, boiling point=354° C., molecular weight=246)

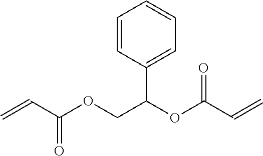 [SMILES: C=CC(=O)OCC(OC(=O)C=C)c1ccccc1]

2-phenyl-1,3-propanediol diacrylate (PhPDA, OP=3.18, boiling point=340° C., 80° C. vapor pressure<0.0017 mmHg, molecular weight=260)

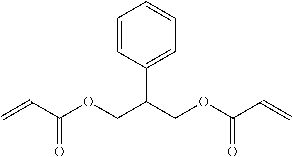 [SMILES: C=CC(=O)OCC(COC(=O)C=C)c1ccccc1]

VmXDA indicated by the formula below (OP=3.00, boiling point=372.4° C., 80° C. vapor pressure=0.0005 mmHg, molecular weight=272.3)

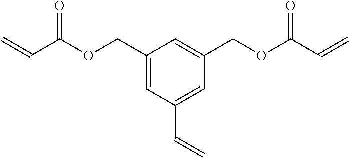 [SMILES: C=CC(=O)OCc1cc(C=C)cc(COC(=O)C=C)c1]

BPh44DA indicated by the formula below (OP=2.63, boiling point=444° C., 80° C. vapor pressure<0.0001 mmHg, molecular weight=322.3)

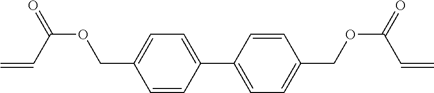 [SMILES: C=CC(=O)OCc1ccc(-c2ccc(COC(=O)C=C)cc2)cc1]

BPh43DA indicated by the formula below (OP=2.63, boiling point=439.5° C., 80° C. vapor pressure<0.0001 mmHg, molecular weight=322.3)

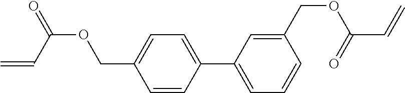 [SMILES: C=CC(=O)OCc1ccc(-c2cccc(COC(=O)C=C)c2)cc1]

DPhEDA indicated by the formula below (OP=2.63, boiling point=410° C., 80° C. vapor pressure<0.0001 mmHg, molecular weight=322.3)

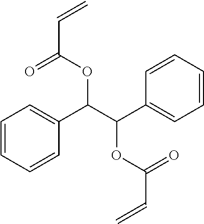 [SMILES: C=CC(=O)OC(c1ccccc1)C(OC(=O)C=C)c1ccccc1]

BPMDA indicated by the formula below (OP=2.68, boiling point=465.7° C., 80° C. vapor pressure<0.0001 mmHg, molecular weight=364.4)

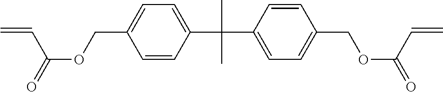 [SMILES: C=CC(=O)OCc1ccc(C(C)(C)c2ccc(COC(=O)C=C)cc2)cc1]

Na13MDA indicated by the formula below (OP=2.71, boiling point=438.8° C., 80° C. vapor pressure<0.0001 mmHg, molecular weight=296.3)

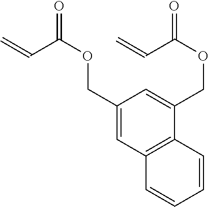 [SMILES: C=CC(=O)OCc1cc(COC(=O)C=C)c2ccccc2c1]

At least a part of the polymerizable compound (a) which may include a plurality of types of additive components can be polymers having a polymerizable functional group. The polymer preferably contains at least a cyclic structure such as an aromatic structure, an aromatic heterocyclic structure, or an alicyclic structure. For example, the polymer preferably contains at least one of constituent units represented by structures (1) to (6) below:

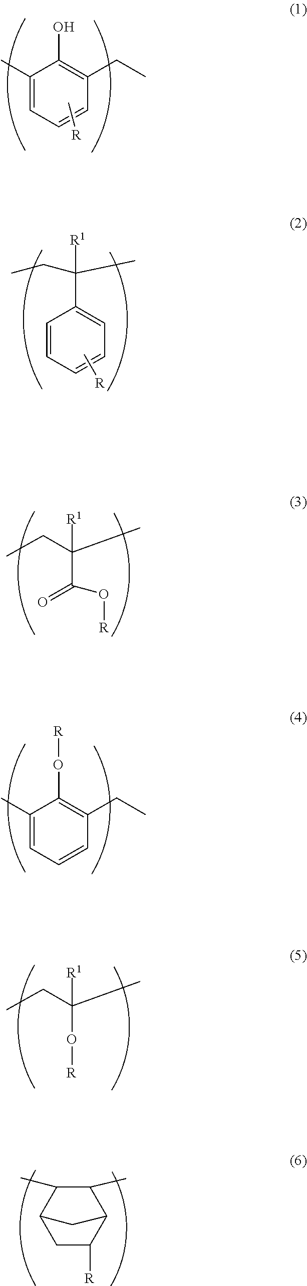

In the structures (1) to (6), a substituent group R is a substituent group containing partial structures each independently containing an aromatic ring, and R¹ is a hydrogen atom or a methyl group. In this specification, in constituent units represented by the structures (1) to (6), a portion other than R is the main chain of a specific polymer. The formula weight of the substituent group R is 80 or more, preferably 100 or more, more preferably 130 or more, and further preferably 150 or more. The upper limit of the formula weight of the substituent group R is practically 500 or less.

A polymer having a polymerizable functional group is normally a compound having a weight-average molecular weight of 500 or more. The weight-average molecular weight is preferably 1,000 or more, and more preferably 2,000 or more. The upper limit of the weight-average molecular weight is not particularly determined, but is preferably, for example, 50,000 or less. When the weight-average molecular weight is set at the above-described lower limit or more, it is possible to set the boiling point at 250° C. or more, and further improve the mechanical properties after curing. Also, when the weight-average molecular weight is set at the above-described upper limit or less, the solubility to the solvent increases, the flowability immediately after the curable composition (A) is arranged using the spin coating is maintained because the viscosity is not too high, and flatness (reflow properties) by flowability can further be improved. Note that the weight-average molecular weight (Mw) in the present disclosure is a molecular weight measured by gel permeation chromatography (GPC), unless it is specifically stated otherwise.

Practical examples of the polymerizable functional group of the polymer are a (meth)acryloyl group, an epoxy group, an oxetane group, a methylol group, a methylol ether group, and a vinyl ether group. A (meth)acryloyl group is particularly favorable from the viewpoint of polymerization easiness.

When adding the polymer having the polymerizable functional group as at least a part of the polymerizable compound (a), the blending ratio can freely be set as long as the blending ratio falls within the range of the viscosity regulation to be described later. For example, the blending ratio of polymer to the total mass of all the components except for the solvent (d) is preferably 0.1 wt % or more and 60 wt % or less, more preferably 0.1 wt % or more and 50 wt % or less, and further preferably 0 wt % or more and 40 wt % or less. When the blending ratio of the polymer having the polymerizable functional group is set at 0.1 wt % or more, it is possible to improve the heat resistance, the dry etching resistance, the mechanical strength, and the low volatility. Also, when the blending ratio of the polymer having the polymerizable functional group is set at 60 wt % or less, it is possible to make the blending ratio fall within the range of the upper limit regulation of the viscosity (to be described later).

As the polymerizable compound (a) selected as the curable composition (A), one type or a plurality of types of polymerizable compounds may be used. These preferably have a viscosity less than 10,000 mPa·s at 20° C. to 170° C. and more preferably have a viscosity less than 1,000 mPa·s. When such a polymerizable compound (a) having a low viscosity is used, flowability can be obtained.

Also, in the present disclosure, the polymerizable compound (a) is represented by one of the following chemical formulas.

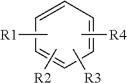

R1 and R2 are vinyl groups or propenyl groups
R3 and R4 are hydrogen atoms or vinyl groups

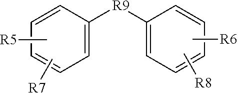

R5 and R6 are vinyl groups or propenyl groups
R7 and R8 are hydrogen atoms or vinyl groups
R9 is a single bond or a linear or oxygen atom or carbonyl group whose carbon number is 1 to 2

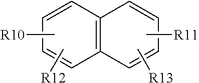

R10 and R11 are vinyl groups or propenyl groups
R12 and R13 are hydrogen atoms or vinyl groups
   <Polymerization Initiator (b)>

In this specification, the polymerization initiator (b) is a compound that generates the polymerizing factor (a radical or a cation) by heat or light. More specifically, examples of the polymerization initiator (b) are a radical generator that generates a radical by heat or light and an acid generator that generates a proton (H+) by heat or light. The radical generator is used mainly in a case where the polymerizable compound (a) contains a radical polymerizable compound. On the other hand, the acid generator is used mainly in a case where the polymerizable compound (a) contains a cation polymerizable compound. As the polymerization initiator (b) according to the present disclosure, a thermal polymerization initiator (bt) and/or the photopolymerization initiator (bp) can be used.

<Thermal Polymerization Initiator (bt)>

Examples of the thermal radical generator are an organic peroxide and an azo compound.

Examples of the organic peroxide are as follows, but the organic peroxide is not limited to these examples.
peroxyesters such as t-hexylperoxyisopropyl monocarbonate, t-hexylperoxy-2-ethylhexanoate, t-butylperoxy-3,5,5-trimethylhexanoate, and t-butylperoxyisopropyl carbonates, peroxyketals such as 1,1-bis(t-hexylperoxy)3,3,5-trimethylcyclohexane, and diacyl peroxides such as lauroyl peroxide

Examples of the azo compound are as follows, but the azo compound is not limited to these examples.
azonitriles such as 2,2′-azobisisobutyronitrile, 2,2′-azobis(2-methylbutyronitrile), and 1,1′-azobis(cyclohexane-1-carbonitrile)

Examples of a thermal acid generator are known iodonium salt, sulfonium salt, phosphonium salt, and ferrocenes.

Practical examples of the thermal acid generator are as follows, but the thermal acid generator is not limited to these examples.
diphenyliodonium hexafluoroantimonate, diphenyliodonium hexafluorophosphate, diphenyliodonium hexafluoroborate, triphenylsulfonium hexafluoroantimonate, triphenylsulfonium hexafluorophosphate, and triphenylsulfonium hexafluoroborate
   <Photopolymerization Initiator (bp)>

In this specification, the photopolymerization initiator (bp) is a compound that senses light having a predetermined wavelength and generates a polymerizing factor (a radical or a cation) described earlier. More specifically, the photopolymerization initiator (bp) is a polymerization initiator that generates a radical or a cation by light (infrared light, visible light, ultraviolet light, far-ultraviolet light, X-ray, a charged particle beam such as an electron beam, or radiation). The photopolymerization initiator (bp) can be formed by only one type of photopolymerization initiator, and can also be formed by a plurality of types of photopolymerization initiators.

Examples of the radical generator are as follows, but the radical generator is not limited to these examples.

2,4,5-triarylimidazole dimers that can have substituent groups, such as a 2-(o-chlorophenyl)-4,5-diphenylimidazole dimer, a 2-(o-chlorophenyl)-4,5-di(methoxyphenyl)imidazole dimer, a 2-(o-fluorophenyl)-4,5-diphenylimidazole dimer, and a 2-(o- or p-methoxyphenyl)-4,5-diphenylimidazole dimer; benzophenone derivatives such as benzophenone, N,N′-tetramethyl-4,4′-diaminobenzophenone (Michiler's ketone), N,N′-tetraethyl-4,4′-diaminobenzophenone, 4-methoxy-4′-dimethylaminobenzophenone, 4-chlorobenzophenone, 4,4′-dimethoxybenzophenone, and 4,4′-diaminobenzophenone; α-amino aromatic ketone derivatives such as 2-benzyl-2-dimethylamino-1-(4-morpholinophenyl)-butanone-1,2-methyl-1-[4-(methylthio)phenyl]-2-morpholino-propane-1-one; quinones such as 2-ethylanthraquinone, phenanthrenequinone, 2-t-butylanthraquinone, octamethylanthraquinone, 1,2-benzanthraquinone, 2,3-benzanthraquinone, 2-phenylanthraquinone, 2,3-diphenylanthraquinone, 1-chloroanthraquinone, 2-methylanthraquinone, 1,4-napthoquinone, 9,10-phenanthraquinone, 2-methyl-1,4-napthoquinone, and 2,3-dimethylanthraquinone; benzoin ether derivatives such as benzoin methyl ether, benzoin ethyl ether, and benzoin phenyl ether; benzoin derivatives such as benzoin, methyl benzoin, ethyl benzoin, and propyl benzoin; benzyl derivatives such as benzyldimethylketal; acridine derivatives such as 9-phenylacridine and 1,7-bis(9,9′-acrydinyl)heptane; N-phenylglycine derivatives such as N-phenylglycine; acetophenone derivatives such as acetophenone, 3-methylacetophenone, acetophenone benzylketal, 1-hydroxycyclohexyl phenylketone, and 2,2-dimethoxy-2-phenyl acetophenone; thioxanthone derivatives such as thioxanthone, diethylthioxanthone, 2-isopropylthioxanthone, and 2-chlorothioxanthone; acylphosphine oxide derivatives such as 2,4,6-trimethylbenzoyldiphenylphosphine oxide, bis(2,4,6-trimethylbenzoyl)phenylphosphine oxide, and bis-(2,6-dimethoxybenzoyl)-2,4,4-trimethylpentylphosphine oxide; oxime ester derivatives such as 1,2-octanedione, 1-[4-(phenylthiol)-,2-(O-benzoyloxime)], ethanone, 1-[9-ethyl-6-(2-methylbenzoyl)-9H-carbazole-3-yl]-, and 1-(O-acetyloxime); and xanthone, fluorenone, benzaldehyde, fluorene, anthraquinone, triphenylamine, carbazole, 1-(4-isopropylphenyl)-2-hydroxy-2-methylpropane-1-one, and 2-hydroxy-2-methyl-1-phenylpropane-1-one.

Examples of the commercially available products of the above-described radical generators are as follows, but the products are not limited to these examples.

Irgacure 184, 369, 651, 500, 819, 907, 784, and 2959, CGI-1700, -1750, and -1850, CG24-61, Darocur 1116 and 1173, Lucirin® TPO, LR8893, and LR8970 (manufactured by BASF), and Ubecryl P36 (manufactured by UCB).

Of the above-described radical generators, the polymerization initiator (b) is preferably an acylphosphine oxide-based polymerization initiator. Note that of the above-described radical generators, the acylphosphine oxide-based polymerization initiators are as follows.

Acylphosphine oxide compounds such as 2,4,6-trimethylbenzoyl diphenylphosphine oxide, bis(2,4,6-trimethylbenzoyl)phenylphosphine oxide, and bis(2,6-dimethoxybenzoyl)-2,4,4-trimethylpentylphosphine oxide.

Practical examples of a photoacid generator are as follows, but the photoacid generator is not limited to these examples.

onium salt compounds such as diphenyliodonium trifluoromethanesulfonate, diphenyliodonium p-toluenesulfonate, diphenyliodonium hexafluoroanthimonate, diphenyliodonium hexafluorophosphate, diphenyliodonium tetrafluoroborate, triphenylsulfonium trifluoromethanesulfonate, triphenylsulfonium hexafluoroanthimonate, triphenylsulfonium hexafluorophosphate, 4-t-butylphenyl-diphenylsulfonium trifluoromethanesulfonate, 4-t-butylphenyl-diphenylsulfonium benzenesulfonate, 4,7-di-n-butoxynaphthyltetrahydrothiophenium trifluoromethanesulfonate, 4,7-di-n-butoxynaphthyltetrahydrothiophenium-bis(trifluoromethane-sulfonyl)imide anion, 4,7-di-n-butoxynaphthyltetrahydrothiophenium-bis(nonafluorobutyl-sulfonyl)imide anion, and 4,7-di-n-butoxynaphthyltetrahydrothiophenium-tris(nonafluorobutyl-sulfonyl)methide; halogen-containing compounds such as 1,10-dibromo-n-decane, 1,1-bis(4-chlorophenyl)-2,2,2-trichloroethane, phenyl-bis(trichloromethyl)-s-triazine, 4-methoxyphenyl-bis(trichloromethyl)-s-triazine, styryl-bis(trichloromethyl)-s-triazine, and naphthyl-bis(trichloromethyl)-s-triazine; sulfone compounds such as 4-trisphenacyl sulfone, methylphenacyl sulfone, and bis(phenylsulfonyl) methane; sulfonate compounds such as benzointosylate, pyrogalloltristrifluoromethane sulfonate, o-nitrobenzyl trifluoromethane sulfonate, and o-nitrobenzyl-p-toluene sulfonate; sulfonimide compounds such as N-(trifluoromethylsulfonyloxy)succinimide, N-(trifluoromethylsulfonyloxy)phthalimide, N-(trifluoromethylsulfonyloxy)diphenylmaleimide, N-(trifluoromethylsulfonyloxy)-4-butyl-naphthylimide, N-(trifluoromethylsulfonyloxy)-4-propylthio-naphthylimide, N-(4-methylphenylsulfonyloxy)succinimide, N-(4-methylphenylsulfonyloxy)phthalimide, N-(4-methylphenylsulfonyloxy)diphenylmaleimide, N-(4-methylphenylsulfonyloxy)bicyclo[2.2.1]hept-5-ene-2,3-dicarboxyimide, N-(4-fluorophenylsulfonyloxy)bicyclo[2.1.1]heptane-5,6-oxy-2,3-dicarboxyimide, N-(4-fluorophenylsulfonyloxy)naphthylimide, and N-(10-camphorsulfonyloxy)naphthylimide; and diazomethane compounds such as bis(trifluoromethylsulfonyl)diazomethane, bis(cyclohexylsulfonyl)diazomethane, bis(phenylsulfonyl)diazomethane, bis(p-toluenesulfonyl)diazomethane, methylsulfonyl-p-toluenesulfonyldiazomethane, cyclohexylsulfonyl-1,1-dimethylethylsulfonyldiazomethane, and bis(1,1-dimethylethylsulfonyl)diazomethane.

The blending ratio of the polymerization initiator (b) in the curable composition (A) is preferably 0.1 wt % or more and 50 wt % or less with respect to the sum of the polymerizable compound (a), the polymerization initiator (b), and a nonpolymerizable compound (c) (to be described later), that is, the total mass of all the components except for the solvent (d). Also, the blending ratio of the polymerization initiator (b) in the curable composition (A) is more preferably 0.1 wt % or more and 20 wt % or less, and further preferably 1 wt % or more and 20 wt % or less with respect to the total mass of all the components except for the solvent (d). When the blending ratio of the polymerization initiator (b) in the curable composition (A) is set at 0.1 wt % or more, the curing rate of the composition increases, so the reaction efficiency can be improved. Also, when the blending ratio of the polymerization initiator (b) is set at 50 wt % or less, a cured film having mechanical strength to some extent can be obtained.

<Nonpolymerizable Compound (c)>

In addition to the polymerizable compound (a) and the polymerization initiator (b), the curable composition (A) according to the present disclosure may further contain a nonpolymerizable compound (c) in accordance with various purposes. An example of the nonpolymerizable compound (c) is a compound that does not contain a polymerizable functional group such as a (meth)acryloyl group, and does not solely have the ability to generate the polymerizing factor (radical) described previously. Examples of the nonpolymerizable compound are a sensitizer, a surfactant, a polymerization inhibitor, an antioxidant, a polymer component, and other additives. The nonpolymerizable compound (c) can contain a plurality of types of the above-described compounds.

The sensitizer is a compound that is properly added for the purpose of promoting the polymerization reaction and improving the reaction conversion rate. As the sensitizer, it is possible to use one type of a compound alone, or to use two or more types of compounds by mixing them.

An example of the sensitizer is a sensitizing dye. The sensitizing dye is a compound that is excited by absorbing light having a specific wavelength and has an interaction with the photopolymerization initiator (bp). The “interaction” herein mentioned is energy transfer or electron transfer from the sensitizing dye in the excited state to the photopolymerization initiator (bp).

Practical examples of the sensitizing dye are as follows, but the sensitizing dye is not limited to these examples.

An anthracene derivative, an anthraquinone derivative, a pyrene derivative, a perylene derivative, a carbazole derivative, a benzophenone derivative, a thioxanthone derivative, a xanthone derivative, a coumarin derivative, a phenothiazine derivative, a camphorquinone derivative, an acridinic dye, a thiopyrylium salt-based dye, a merocyanine-based dye, a quinoline-based dye, a styryl quinoline-based dye, a ketocoumarin-based dye, a thioxanthene-based dye, a xanthene-based dye, an oxonol-based dye, a cyanine-based dye, a rhodamine-based dye, and a pyrylium salt-based dye.

<Solvent (d)>

The curable composition (A) contains a solvent having a boiling point of 80° C. or more and less than 250° C. at normal pressure as the solvent (d). The solvent (d) is a solvent that dissolves the polymerizable compound (a), the polymerization initiator (b), and the nonpolymerizable compound (c). Examples are an alcohol-based solvent, a ketone-based solvent, an ether-based solvent, an ester-based solvent, and a nitrogen-containing solvent. As the solvent (d), it is possible to use one type of a component alone, or to use two or more types of components by combining them. The boiling point at normal pressure of the solvent (d) is 80° C. or more, preferably 140° C. or more, and particularly preferably 150° C. or more. The boiling point at normal pressure of the solvent (d) is less than 250° C., and preferably less than 200° C. If the boiling point of the solvent (d) at normal pressure is less than 80° C., the volatilization speed in a planarization step to be described later is too high, and it is impossible to obtain an even film. Also, if the boiling point at normal pressure of the solvent (d) is 250° C. or more, it is possible that volatilization in a baking step after the arranging step to be described later is insufficient, so the solvent(d) may remain in the film.

Examples of the alcohol-based solvent are as follows.

Monoalcohol-based solvents such as methanol, ethanol, n-propanol, iso-propanol, n-butanol, iso-butanol, sec-butanol, tert-butanol, n-pentanol, iso-pentanol, 2-methylbutanol, sec-pentanol, tert-pentanol, 3-methoxybutanol, n-hexanol, 2-methylpentanol, sec-hexanol, 2-ethylbutanol, sec-heptanol, 3-heptanol, n-octanol, 2-ethylhexanol, sec-octanol, n-nonyl alcohol, 2,6-dimethylheptanol-4, n-decanol, sec-undecyl alcohol, trimethylnonyl alcohol, sec-tetradecyl alcohol, sec-heptadecyl alcohol, phenol, cyclohexanol, methylcyclohexanol, 3,3,5-trimethylcyclohexanol, benzyl alcohol, phenylmethylcarbinol, diacetone alcohol, and cresol; and polyalcohol-based solvents such as ethylene glycol, 1,2-propylene glycol, 1,3-butylene glycol, 2,4-pentanediol, 2-methyl-2,4-pentanediol, 1,2-hexanediol, 2,5-hexanediol, 2,4-heptanediol, 2-ethyl-1,3-hexanediol, diethylene glycol, dipropylene glycol, triethylene glycol, tripropylene glycol, and glycerin.

Examples of the ketone-based solvent are as follows.

Acetone, methylethylketone, methyl-n-propylketone, methyl-n-butylketone, diethylketone, methyl-iso-butylketone, methyl-n-pentylketone, ethyl-n-butylketone, methyl-n-hexylketone, di-iso-butylketone, trimethylnonanon, cyclohexanone, methylcyclohexanone, 2,4-pentanedione, acetonylacetone, diacetone alcohol, acetophenone, and fenthion.

Examples of the ether-based solvent are as follows.

Ethyl ether, iso-propyl ether, n-butyl ether, n-hexyl ether, 2-ethylhexyl ether, ethylene oxide, 1,2-propylene oxide, dioxolane, 4-methyldioxolane, dioxane, dimethyldioxane, 2-methoxyethanol, 2-ethoxyethanol, ethylene glycol diethyl ether, 2-n-butoxyethanol, 2-n-hexoxyethanol, 2-phenoxyethanol, 2-(2-ethylbutoxy)ethanol, ethylene glycol dibutyl ether, diethylene glycol monomethyl ether, diethylene glycol monoethyl ether, diethylene glycol diethyl ether, diethylene glycol mono-n-butyl ether, diethylene glycol di-n-butyl ether, diethylene glycol mono-n-hexyl ether, ethoxy triglycol, tetraethylene glycol di-n-butyl ether, 1-n-butoxy-2-propanol, 1-phenoxy-2-propanol, propylene glycol monomethyl ether, propylene glycol monoethyl ether, propylene glycol monopropyl ether, dipropylene glycol monomethyl ether, dipropylene glycol monoethyl ether, dipropylene glycol monopropyl ether, tripropylene glycol monomethyl ether, tetrahydrofuran, and 2-methyltetrahydrofuran.

Examples of the ester-based solvent are as follows.

Diethyl carbonate, methyl acetate, ethyl acetate, amyl acetate, γ-butyrolactone, γ-valerolactone, n-propyl acetate, iso-propyl acetate, n-butyl acetate, iso-butyl acetate, sec-butyl acetate, n-pentyl acetate, sec-pentyl acetate, 3-methoxybutyl acetate, methylpentyl acetate, 2-ethylbutyl acetate, 2-ethylhexyl acetate, benzyl acetate, cyclohexyl acetate, methylcyclohexyl acetate, n-nonyl acetate, methyl acetoacetate, ethyl acetoacetate, ethylene glycol monomethyl ether acetate, ethylene glycol monoethyl ether acetate, diethylene glycol monomethyl ether acetate, diethylene glycol monoethyl ether acetate, diethylene glycol mono-n-butyl ether acetate, propylene glycol monomethyl ether acetate, propylene glycol monoethyl ether acetate, propylene glycol monopropyl ether acetate, propylene glycol monobutyl ether acetate, dipropylene glycol monomethyl ether acetate, dipropylene glycol monoethyl ether acetate, glycol diacetate, methoxy triglycol acetate, ethyl propionate, n-butyl propionate, iso-amyl propionate, diethyl oxalate, di-n-butyl oxalate, methyl lactate, ethyl lactate, n-butyl lactate, n-amyl lactate, diethyl malonate, dimethyl phthalate, and diethyl phthalate.

Examples of the nitrogen-containing solvent are as follows.

N-methylformamide, N,N-dimethylformamide, N,N-diethylformamide, acetamide, N-methylacetamide, N,N-dimethylacetamide, N-methylpropionamide, and N-methylpyrrolidone.

Of the above-described solvents, the ether-based solvent and the ester-based solvent are favorable as the solvent (d). Note that an ether-based solvent and an ester-based solvent each having a glycol structure are more favorable as the solvent (d) from the viewpoint of good film formation properties. Further favorable examples of the solvent (d) are as follows.

Propylene glycol monomethyl ether, propylene glycol monoethyl ether, propylene glycol monopropyl ether, propylene glycol monomethyl ether acetate, propylene glycol monoethyl ether acetate, and propylene glycol monopropyl ether acetate.

Particularly favorable examples of the solvent (d) are propylene glycol monomethyl ether acetate and isocyanurate di(meth)acrylate.

A favorable solvent is a solvent having at least one of an ester structure, a ketone structure, a hydroxyl group, and an ether structure. More specifically, a favorable solvent is one solvent or a solvent mixture selected from propylene glycol monomethyl ether acetate (boiling point=146° C.), propylene glycol monomethyl ether, cyclohexanone, 2-heptanone, γ-butyrolactone, and ethyl lactate.

A polymerizable compound having a boiling point of 80° C. or more and less than 250° C. at normal pressure is also usable as the solvent (d). Examples of the polymerizable compound having a boiling point of 80° C. or more and less than 250° C. at normal pressure are as follows.

Cyclohexyl acrylate (boiling point=198° C.), benzyl acrylate (boiling point=229° C.), isobornyl acrylate (boiling point=245° C.), tetrahydrofurfuryl acrylate (boiling point=202° C.), trimethylcyclohexyl acrylate (boiling point=232° C.), isooctyl acrylate (217° C.), n-octyl acrylate (boiling point=228° C.), ethoxyethoxyethyl acrylate (boiling point=230° C.), divinylbenzene (boiling point=193° C.), 1,3-diisopropenylbenzene (boiling point=218° C.), styrene (boiling point=145° C.), and α-methylstyrene (boiling point=165° C.).

When the whole of the curable composition (A) is 100 vol %, the content of the solvent (d) is 70 vol % or more, preferably 80 vol % or more, and particularly preferably 90 vol % or more. If the content of the solvent (d) is smaller than 80 vol %, it is difficult to obtain a thin film in the arranging step using the spin coating method.

### <Temperature When Blending Curable Composition (A)>

When preparing the curable composition (A) according to the present disclosure, at least the polymerizable compound (a), the polymerization initiator (b), and the solvent(d) are mixed and dissolved under a predetermined temperature condition. More specifically, the predetermined temperature condition can be 0° C. or more and 100° C. or less. Note that the same applies to a case where the curable composition (A) contains the nonpolymerizable compound (c).

### <Viscosity of Curable Composition>

The curable composition (A) is arranged using the spin coating method in the arranging step. Hence, the viscosity of the curable composition (A) is 1 mPa·s or more and 100 mPa·s or less at 23° C. and at 1 atm, preferably 1 mPa·s or more and 20 mPa·s or less, and particularly preferably 1 mPa·s or more and 5 mPa·s or less. If the viscosity of the curable composition (A) is larger than 100 mPa·s, it is difficult to obtain a thin film.

The curable composition (A) in which the solvent (d) is completely volatilized, that is, the composition obtained by removing the solvent (d) from the curable composition (A) has a viscosity of, for example, 10 mPa·s or more and 10,000 mPa·s or less at 23° C. The composition obtained by removing the solvent (d) from the curable composition (A) will also be referred to as a curable composition (A′) hereinafter. The viscosity of the curable composition (A′) can be 20 mPa·s or more and 1,000 mPa·s or less at 23° C., preferably 50 mPa·s or more and 500 mPa·s or less, and more preferably 50 mPa·s or more and 150 mPa·s or less. When the viscosity of the curable composition (A′) at 23° C. is set to 1,000 mPa·s or less, flowability can be obtained.

### <Impurities Mixed in Curable Composition>

The curable composition (A) preferably contains impurities as little as possible. Note that impurities mean components other than the polymerizable compound (a), the polymerization initiator (b), the nonpolymerizable compound (c), and the solvent (d). Therefore, the curable composition (A) is favorably a composition obtained through a refining step. A refining step like this is preferably filtration using a filter.

As this filtration using a filter, it is favorable to mix the polymerizable compound (a), the polymerization initiator (b), and the nonpolymerizable compound (c) and filtrate the mixture by using, for example, a filter having a pore diameter of 0.001 μm or more and 5.0 μm or less. When performing filtration using a filter, is it further favorable to perform the filtration in multiple stages, or to repetitively perform the filtration a plurality of times (cycle filtration). It is also possible to re-filtrate a liquid once filtrated through a filter, or perform filtration by using filters having different pore diameters. Examples of the filter for use in filtration are filters made of, for example, a polyethylene resin, a polypropylene resin, a fluorine resin, and a nylon resin, but the filter is not particularly limited. Impurities such as particles mixed in the curable composition (A) can be removed through the refining step as described above. Consequently, it is possible to prevent impurities mixed in the curable composition (A) from causing pattern defects by forming unexpected unevenness in the cured film (underlayer film) obtained after the curable composition (A) is cured.

When using the curable composition (A) in order to fabricate a semiconductor integrated circuit, it is favorable to avoid mixing of impurities (metal impurities) containing metal atoms in the curable composition (A) as much as possible so as not to obstruct the operation of a product. The concentration of the metal impurities contained in the curable composition (A) is preferably 10 ppm or less, and more preferably 100 ppb or less.

### [Film Forming Method]

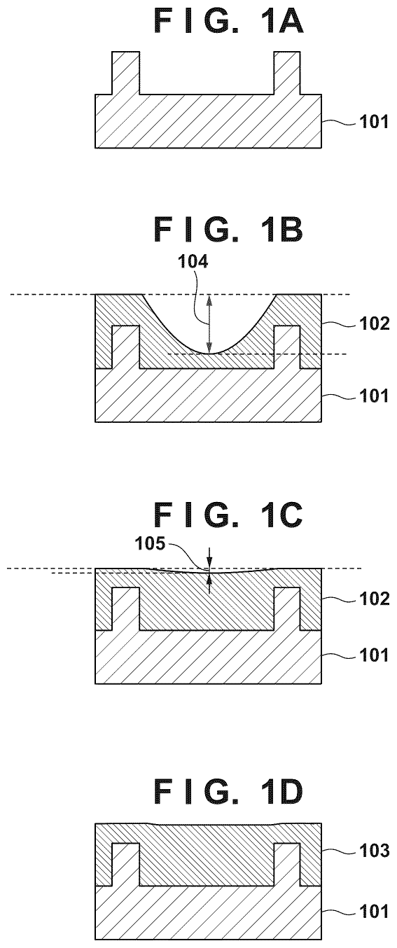

A film forming method according to one aspect of the present disclosure will be described with reference to FIGS. 1A to 1D. The film forming method according to the present disclosure is applied to, for example, a planarization technique for planarizing the surface of a substrate, and an underlayer film is formed as a film of the curable composition (A) on a substrate having unevenness (concave-convex shape) on the surface. The film forming method according to the present disclosure includes an arranging step, a planarization step, and a curing step. The planarization step is executed after the arranging step, and the curing step is executed after the arranging step.

### <Arranging Step>

The arranging step will be described with reference to FIGS. 1A and 1B. The arranging step is a step of arranging an underlayer film formation composition 102, as shown in FIG. 1B, on a substrate 101 (base) having a concave-convex shape as shown in FIG. 1A. More specifically, using the spin coating method, the curable composition (A) containing the polymerizable compound (a) and the solvent (d) is arranged (spin-coated) on the substrate as the underlayer film formation composition 102. As shown in FIG. 1B, if the concave-convex shape of the substrate 101 is large, the underlayer film formation composition 102 is affected by the concave-convex shape. For this reason, a step difference 104 is generated in the underlayer film formation composition 102 immediately after completion of spin coating, and the surface is readily uneven. Typically, the underlayer film formation composition 102 is formed by the curable composition (A) from which the solvent (d) is completely volatilized, that is, the curable composition (A′) that is a composition obtained by removing the solvent (d). The underlayer film formation composition 102 obtained by removing the solvent (d) will be referred to as an underlayer film composition hereinafter.

### <Planarization Step>

The planarization step will be described with reference to FIGS. 1B and 1C. The planarization step is a step of planarizing the underlayer film formation composition 102 arranged on the substrate, thereby forming an underlayer film. More specifically, using the flowability of the underlayer film formation composition 102, the step difference 104 shown in FIG. 1B is planarized such that a desired (allowable) step difference 105 is obtained, as shown in FIG. 1C. In this embodiment, the planarization step is executed by waiting until the step difference 104 changes to the desired step difference 105 in the underlayer film formation composition 102 immediately after completion of spin coating. The desired step difference 105 is basically less than 15 nm, preferably 4 nm, and more preferably less than 0.1 nm. In the planarization step, since the flowability of the underlayer film formation composition 102 is used, the substrate 101 on which the underlayer film formation composition 102 is arranged is left stand in a room temperature environment at about 23° C. To more quickly implement planarization of the underlayer film formation composition 102, a heating step of heating the underlayer film formation composition 102 to lower the viscosity and thus speeding up planarization of the underlayer film formation composition 102 may be provided. In the heating step, the temperature to heat the underlayer film formation composition 102 is appropriately adjusted in accordance with the blending composition of the composition, and the temperature is normally 23° C. or more and 120° C. or less and preferably 50° C. or more and 100° C. or less.

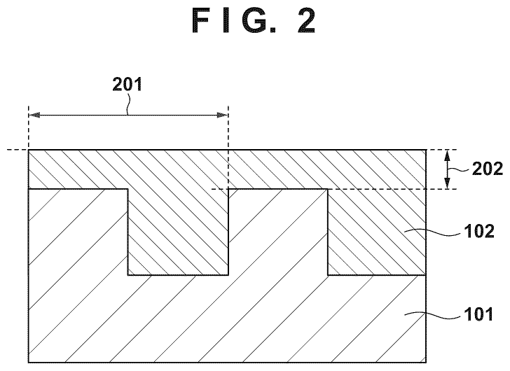

Time required for the planarization step greatly depends on the viscosity of the underlayer film formation composition 102, the period (spatial period) of the concave-convex shape of the substrate 101, and the thickness of the thin film portion of the underlayer film formation composition 102 (underlayer film 103). FIG. 2 is a view corresponding to FIG. 1C, and is a view showing a state in which the planarization step is executed and the underlayer film formation composition 102 is planarized. Referring to FIG. 2, the planarized underlayer film formation composition 102 is formed on the substrate 101. A period 201 (λ [μm]) of the concave-convex shape of the substrate 101 is the length of unevenness (pattern) when the shape of the surface (base) of the substrate 101 spatially has a repetitive structure. Also, a thickness 202 (d_{f} [nm]) of the thinnest portion of the underlayer film formation composition 102 is the thickness of the underlayer film formation composition 102 in a convex portion (most convex portion) of the concave-convex shape of the substrate 101 after planarization is completed. In other words, the thickness 202 of the thinnest portion of the underlayer film formation composition 102 corresponds to the thickness of the curable composition (A) after curing (underlayer film 103) on the convex portion of the concave-convex shape of the substrate 101. In addition to these, time required for the planarization step is substantially determined by the viscosity of the underlayer film composition (the viscosity of the composition obtained by removing the solvent (d) from the curable composition (A)) μ [mPa·s].

Realistically speaking, time required for the planarization step is limited from the viewpoint of throughput. The time is normally 0.1 sec or more and less than 200 sec, and preferably 0.1 sec or more and less than 60 sec. In addition, the period 201 of the concave-convex shape of the substrate 101 is determined by the substrate as the target of planarization. The period 201 of the concave-convex shape of the substrate 101 is normally 33 mm or less, preferably 100 μm or less, and further preferably 10 μm or less. Note that the period 201 of the concave-convex shape of the substrate 101 is the maximum period of a pattern in a shot region on the substrate on which the underlayer film is formed. Furthermore the thickness 202 of the thinnest portion of the underlayer film formation composition 102 is determined in accordance with the purpose. The thickness 202 of the thinnest portion of the underlayer film formation composition 102 is normally 1 nm or more and less than 1 mm, preferably 10 nm or more and less than 200 nm, and further preferably 10 nm or more and less than 50 nm.

As described above, if the period 201 of the concave-convex shape of the substrate 101 and the thickness 202 of the thinnest portion of the underlayer film formation composition 102 are determined, to achieve the desired step difference 105 in the planarization step, the range of the viscosity μ [mPa·s] of the underlayer film composition is limited, as indicated by inequality (3) below. Note that a function f(λ, d_{f}) in inequality (3) will be described later.

$$μ < f ( λ , {d}_{f} ) \qquad ( 3 )$$

### <Curing Step>

The curing step will be described with reference to FIGS. 1C and 1D. The curing step is a step of curing the underlayer film formation composition 102 (underlayer film composition) shown in FIG. 1C, thereby forming the cured film 103, as shown in FIG. 1D. The cured film 103 does not flow and does not change the shape in the range of a realistic time, like a solid or glass.

As a method of curing the underlayer film composition, for example, a method of irradiating the underlayer film composition with light can be applied, and the light to irradiate the underlayer film composition is selected in accordance with the sensitivity wavelength of the underlayer film composition. More specifically, the light to irradiate the underlayer film composition is properly selected from ultraviolet light, X-ray, and an electron beam each having a wavelength of 150 nm or more and 400 nm or less. Note that the light to irradiate the underlayer film composition is particularly preferably ultraviolet light. This is so because many compounds commercially available as curing assistants (photopolymerization initiators) have sensitivity to ultraviolet light.

As the method of curing the underlayer film composition, a method of heating the underlayer film composition can also be applied. The temperature to heat the underlayer film composition is, for example, 300° C. or more and 400° C. or less, preferably 80° C. or more and 250° C. or less, and particularly preferably 90° C. or more and 220° C. or less. Time to heat the underlayer film composition is, for example, 10 sec or more and 600 sec or less. Heating of the underlayer film composition can be executed using a known heating device such as a hot plate or an oven. If the heating step is employed in the planarization step, in the curing step, the underlayer film composition is heated to a temperature higher than in the heating step of the planarization step and it is necessary to use the underlayer film composition (curable composition) that is cured at a high temperature.

Also, as the method of curing the underlayer film composition, the method of irradiating the underlayer film composition with light and the method of heating the underlayer film composition may be used together.

### [Article Manufacturing Method]

An article manufacturing method includes a forming step of forming a film of a curable composition on a substrate using the above-described film forming method, a processing step of processing the substrate on which the film of the curable composition is formed in the forming step, and a manufacturing step of manufacturing an article from the substrate processed in the processing step.

The film (cured film) formed by the film forming method of the present disclosure can directly be used as at least a partial constituent member of various kinds of articles. The film (cured film) formed by the film forming method of the present disclosure can temporarily be used as a mask for etching or ion implantation with respect to the substrate (a layer to be processed when the substrate has the layer to be processed). This mask is removed after etching or ion implantation is performed in a processing step of the substrate. Consequently, various kinds of articles can be manufactured.

When removing a cured product in recesses of the cured film by etching, a practical method is not particularly limited, and a known method such as dry etching can be used. A conventionally known dry etching apparatus can be used in this dry etching. A source gas for dry etching is appropriately selected in accordance with an element composition of the cured product to be etched. More specifically, it is possible to use halogen gases such as CF₄, C₂F₆, C₃F₈, CCl₂F₂, CCl₄, CBrF₃, BCl₃, PCl₃, SF₆, and Cl₂ as the source gas. As the source gas, it is also possible to use gases containing oxygen atoms such as O₂, CO, and CO₂, inert gases such as He, N₂, and Ar, and gases such as H₂ and NH₃ as the source gas. Note that these gases can also be mixed and used as the source gas. In this case, the cured film is required to have a high dry etching resistance in order to process the base substrate with high yield.

An article is, for example, an electric circuit element, an optical element, MEMS, a recording element, a sensor, or a mold. Examples of the electric circuit element are volatile or nonvolatile semiconductor memories such as a DRAM, an SRAM, a flash memory, and an MRAM, and semiconductor elements such as an LSI, a CCD, an image sensor, and an FPGA. Examples of the optical element are a micro lens, a light guide body, a waveguide, an antireflection film, a diffraction grating, a polarizer, a color filter, a light-emitting element, a display, and a solar battery. Examples of the MEMS are a DMD, a microchannel, and an electromechanical transducer. Examples of the recording element are optical disks such as a CD and a DVD, a magnetic disk, a magneto-optical disk, and a magnetic head. Examples of the sensor are a magnetic sensor, a photosensor, and a gyro sensor. An example of the mold is a mold for imprinting.

A known photolithography step such as an imprint lithography technique or an extreme ultraviolet exposure technique (EUV) can be performed on the planarization film formed by the film forming method of the present disclosure. It is also possible to stack a spin-on-glass (SOG) film and/or a silicon oxide layer, and perform a photolithography step by applying a curable composition on that. Consequently, a device such as a semiconductor device can be fabricated. It is further possible to form an apparatus including the device, for example, an electronic apparatus such as a display, a camera, or a medical apparatus. Examples of the device are an LSI, a system LSI, a DRAM, an SDRAM, an RDRAM, a D-RDRAM, and a NAND flash memory.

### EXAMPLES

More practical examples will be explained in order to supplement the above-described embodiments.

### Example 1

This example shows that a curable composition (A) (underlayer film composition) is planarized in the planarization step, and the upper limit of a viscosity μ [mPa·s] of the curable composition (A) is a function of a period λ of the concave-convex shape of the substrate and a thickness d_{f} [nm] of the thinnest portion of the underlayer film.

On the substrate, which is the target of the planarization step, a liquid film of the curable composition (A) is formed by the centrifugal force of the spin coating method in the arranging step. Since the liquid film of the curable composition (A) is mainly formed by the centrifugal force, in this numerical calculation, it was assumed that a liquid film having an even thickness was formed, independently of the concave-convex shape of the substrate, and an initial liquid film distribution was formed.

In the planarization step, the initial liquid film distribution is planarized using the flowability of the curable composition (A). In this example, the flowing process of the curable composition (A) was calculated using a Navier-Stokes equation that had undergone thin-film approximation (lubrication theory) with a free surface.

$$\frac{\partial h}{\partial t} = - ∇ \cdot ( \frac{{h}^{3}}{3 μ} ∇ ( σ {∇}^{2} h ) ) \qquad ( 4 )$$

In equation (4), h is the height of the liquid film of the curable composition (A), μ is the viscosity (viscosity coefficient) of the curable composition (A), and a is the surface tension (surface tension coefficient). In this example, the surface tension of the curable composition (A) was 35 mN/m.

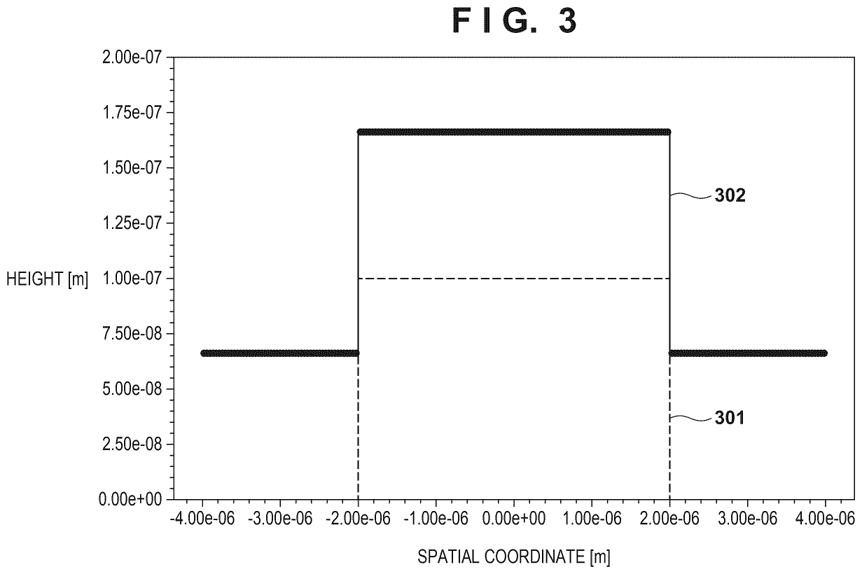

FIG. 3 is a graph showing an example of the relationship between the concave-convex shape of the substrate and the initial liquid film distribution. In FIG. 3, the abscissa indicates a spatial coordinate [m], and the ordinate indicates the height of the liquid film of the curable composition (A). Referring to FIG. 3, a concave-convex shape 301 of the substrate is formed by concave portions and convex portions. In this example, this was calculated based on period boundary conditions. Also, the height of the concave-convex shape of the substrate was 100 nm.

As described above, a liquid film distribution 302 (initial liquid film distribution) of the liquid film of the curable composition (A) at initial time is indicated by an even thickness and exemplarily shown in FIG. 3. In fact, it can be considered that the liquid film distribution 302 immediately after completion of spin coating does not have a discontinuous shape in the concave-convex shape 301 of the substrate and a more moderate distribution is formed, as shown in FIG. 3. However, if the relaxing time is estimated for the discontinuous shape of the liquid film distribution 302, the upper limit of the relaxing time can be evaluated.

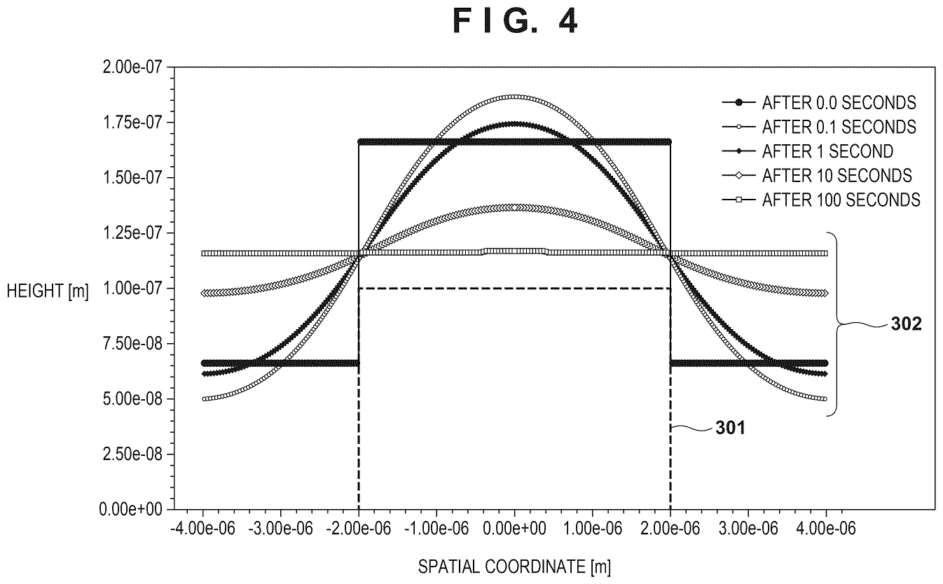

FIG. 4 shows the time-rate change of the liquid film distribution of the curable composition (A) in a case where the period λ of the concave-convex shape of the substrate is 8 μm, and the thickness d_{f} of the thinnest portion of the underlayer film is 25 nm. In FIG. 4, the abscissa indicates the spatial coordinate [m], and the ordinate indicates the height of the liquid film of the curable composition (A). FIG. 4 exemplarily shows liquid film distributions 302 after 0.0 sec (immediately after completion of spin coating), 0.1 sec, 1 sec, 10 sec, and 100 sec from completion of spin coating. Referring to FIG. 4, it is found that along with the elapse of time, planarization of the liquid film of the curable composition (A) gradually progresses, and the liquid film of the curable composition (A) becomes substantially flat after 100 sec from completion of spin coating.

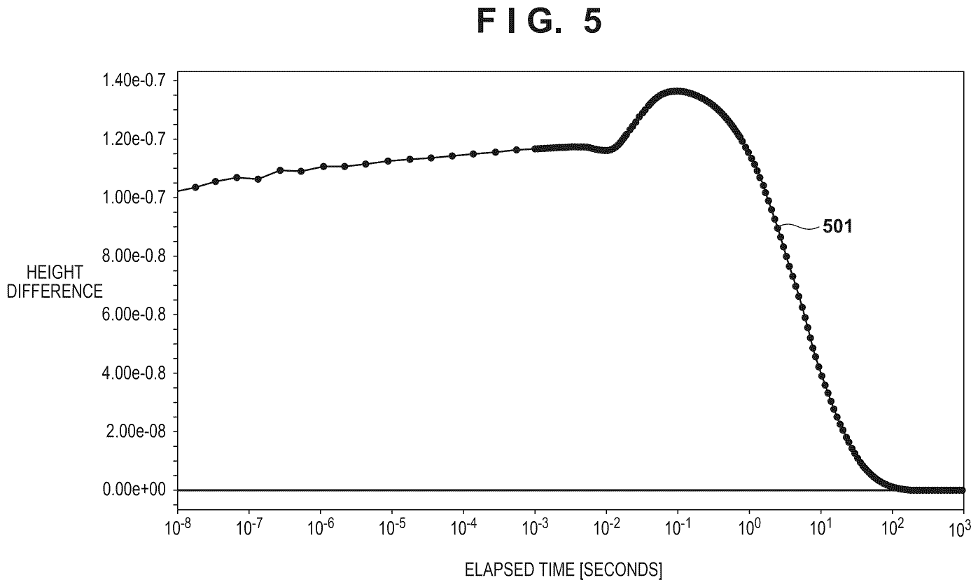

FIG. 5 is a view showing a time-rate change 501 of the height difference of the liquid film distribution 302 of the curable composition (A) shown in FIG. 4. In FIG. 5, the abscissa indicates the elapsed time [sec], and the ordinate indicates the height difference of the liquid film distribution 302 of the curable composition (A). Referring to FIG. 5, it is found that the time-rate change 501 of the height difference of the liquid film distribution 302 of the curable composition (A) reaches the maximum value after the elapse of about 0.1 sec, and after that, attenuation progresses, and the film becomes substantially flat after 100 sec.

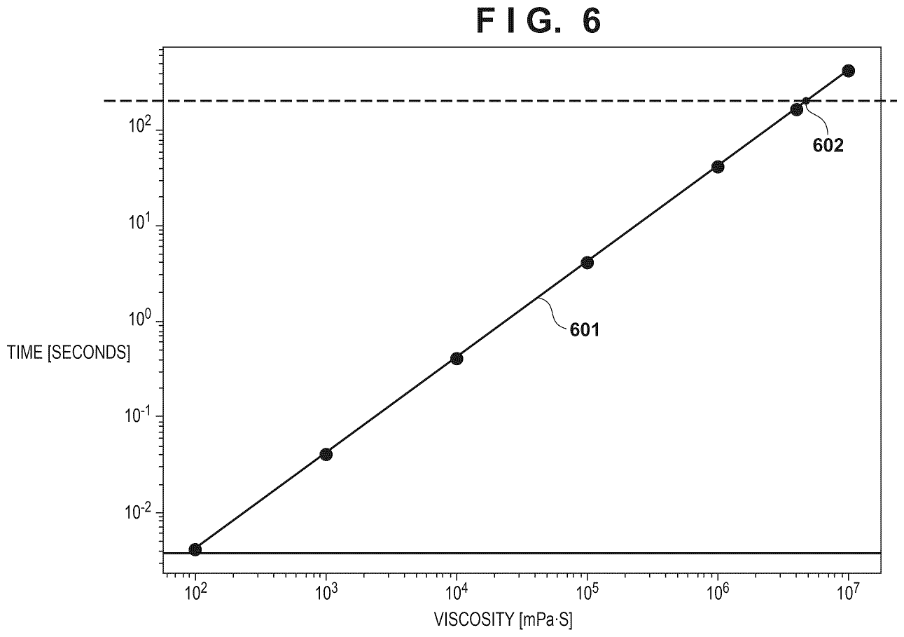

When the viscosity μ [mPa·s] of the curable composition (A) is changed, the time required for the planarization step changes. FIG. 6 is a view showing the time required for the planarization step when the viscosity μ [mPa·s] of the curable composition (A) is changed while setting the period λ of the concave-convex shape of the substrate to 1 μm, the thickness d_{f} of the thinnest portion of the underlayer film to 15 nm, and the desired step difference of the underlayer film as a reference for completion of the planarization step to 0.1 nm. In FIG. 6, the abscissa indicates the viscosity [mPa·s] of the curable composition (A), and the ordinate indicates time [sec]. FIG. 6 exemplarily shows a dependence 601 of time required for the planarization step on the viscosity of the curable composition (A). Referring to FIG. 6, if the time to spare for the planarization step is 200 sec, and the viscosity μ of the curable composition (A) is a viscosity (viscosity coefficient) smaller than the viscosity corresponding to an intersection 602 to 200 sec, the planarization step is completed within 200 sec. Hence, the viscosity corresponding to the intersection 602 is the upper limit value of the viscosity of the curable composition (A) that is planarized within 200 sec.

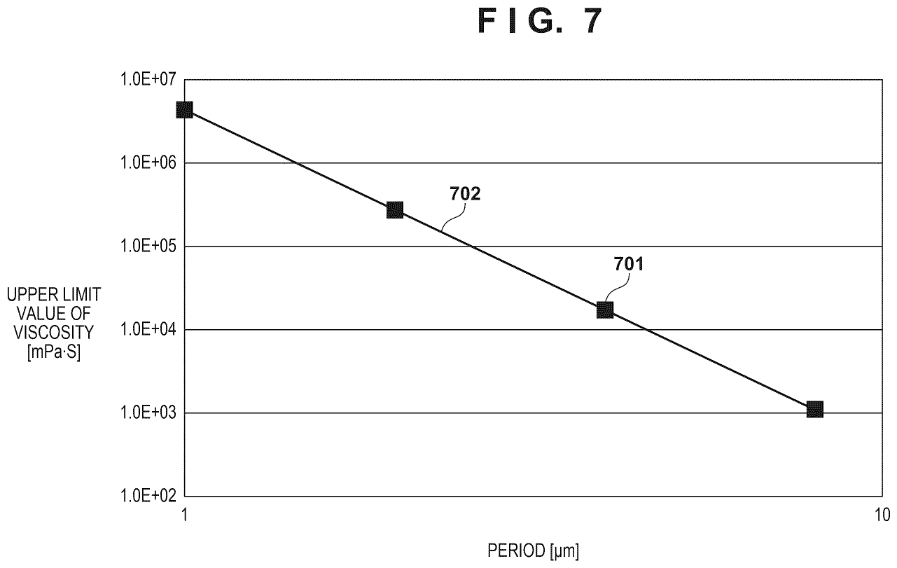

FIG. 7 shows a result of calculating the upper limit value [mPa·s] of the viscosity μ of the curable composition (A) to be planarized within 200 sec while variously changing the period λ [μm] of the concave-convex shape of the substrate. In FIG. 7, the abscissa indicates the period [μm] of the concave-convex shape of the substrate, and the ordinate indicates the upper limit value [mPa·s] of the viscosity μ of the curable composition (A). FIG. 7 exemplarily shows a dependence 701 of the upper limit value of the viscosity of the curable composition (A) on the period (λ) of the concave-convex shape of the substrate, more specifically, a function 702 to which the λ dependence 701 is fitted. Referring to FIG. 7, the function 702 is a function to the power of −4 to the period λ [μm] of the concave-convex shape of the substrate. As shown in FIG. 7, when the period λ [μm] of the concave-convex shape of the substrate becomes large, the upper limit value [mPa·s] of the viscosity μ of the curable composition (A) becomes small.

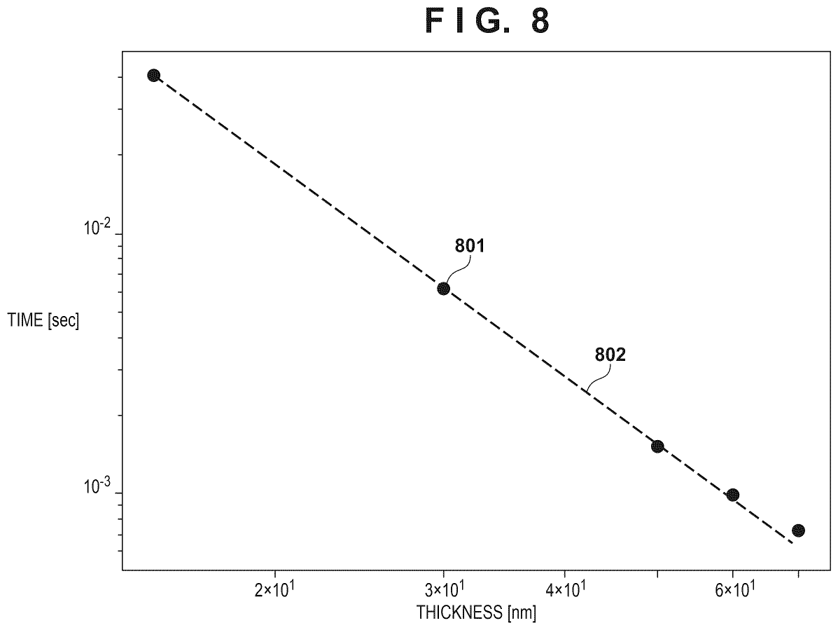

FIG. 8 shows a result of calculating the time [sec] required for the planarization step while variously changing the thickness d_{f} [nm] of the thinnest portion of the underlayer film. In FIG. 8, the abscissa indicates the thickness [μm] of the thinnest portion of the underlayer film, and the ordinate indicates the time [sec] required for the planarization step. FIG. 8 exemplarily shows a dependence 801 of the time required for the planarization step on the thickness (d_{f}) of the thinnest portion of the underlayer film, more specifically, a function 802 to which the d_{f} dependence 801 is fitted, setting the period λ of the concave-convex shape of the substrate to 1 μm and the viscosity μ of the curable composition (A) to 1,000 mPa·s. Referring to FIG. 8, the function 802 is a function to the power of 2.7 to the thickness d_{f} [nm] of the thinnest portion of the underlayer film. As shown in FIG. 8, when the thickness d_{f} [nm] of the thinnest portion of the underlayer film becomes large, the time required for the planarization step becomes short, that is, the upper limit value [mPa·s] of the viscosity μ of the curable composition (A) becomes large.

The above-described results will be summarized. When the viscosity μ [mPa·s] of the curable composition (A) is increased, the time required for the planarization step increases. Hence, when the time required for the planarization step is determined, the upper limit value [mPa·s] of the viscosity μ of the curable composition (A) is determined.

Also, as described above, the time required for the planarization step depends on the period λ [μm] of the concave-convex shape of the substrate and the thickness d_{f} [nm] of the thinnest portion of the underlayer film. Hence, the upper limit of the viscosity μ [mPa·s] of the curable composition (A) is a function of the period λ [μm] of the concave-convex shape of the substrate and the thickness d_{f} [nm] of the thinnest portion of the underlayer film.

Additionally, as described above, the viscosity μ [mPa·s] of the curable composition (A) is a function to the power of −4 to the period λ [μm] of the concave-convex shape of the substrate, and is a function to the power of 2.7 to the thickness d_{f}[nm] of the thinnest portion of the underlayer film. More specifically, the viscosity μ [mPa·s] of the curable composition (A) is smaller than the value of a function f determined by the period λ [μm] of the concave-convex shape of the substrate and the thickness d_{f} [nm] of the thinnest portion of the film, as indicated by equation (5) below.

$$f ( λ , {d}_{f} ) = 4.3 \times {10}^{6} \times {λ}^{- 4} \times {( \frac{{d}_{f}}{15} )}^{2.7} \qquad ( 5 )$$

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims the benefit of Japanese Patent application No. 2024-162452 filed on Sep. 19, 2024, which is hereby incorporated by reference herein in its entirety.

What is claimed is:

1. A film forming method comprising:
arranging a curable composition containing a polymerizable compound and a solvent on a substrate using a spin coating method; and
planarizing the curable composition arranged on the substrate to form a film,
wherein a viscosity μ [mPa·s] of a composition obtained by removing the solvent from the curable composition is smaller than a value of a function f
$$f ( λ , {d}_{f} ) = 4.3 \times {10}^{6} \times {λ}^{- 4} \times {( \frac{{d}_{f}}{15} )}^{2.7}$$
determined by a period λ [μm] of a concave-convex shape of the substrate and a thickness d_{f} [nm] of the curable composition after curing.

2. The method according to claim 1, wherein the period λ includes a maximum period of a pattern in a shot region on the substrate on which the film is formed.

3. The method according to claim 1, wherein the period λ is not more than 10 μm.

4. The method according to claim 1, wherein the thickness d_{f} is not less than 10 nm and less than 50 nm.

5. The method according to claim 1, wherein
the polymerizable compound contains a compound containing not less than one aromatic ring or aromatic heterocycle and not less than two vinyl groups directly combining with the aromatic ring or aromatic heterocycle,
the curable composition further contains a polymerization initiator, and
a content of the solvent with respect to the whole curable composition is not less than 80 vol %.

6. The method according to claim 1, wherein
the polymerizable compound is represented by one of 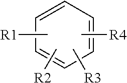
where R1 and R2 are vinyl groups or propenyl groups and R3 and R4 are hydrogen atoms or vinyl groups, 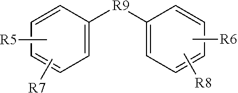
where R5 and R6 are vinyl groups or propenyl groups, R7 and R8 are hydrogen atoms or vinyl groups, and R9 is a single bond or a linear or oxygen atom or carbonyl group whose carbon number is 1 to 2, and 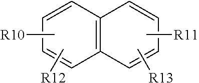
where R10 and R11 are vinyl groups or propenyl groups and R12 and R13 are hydrogen atoms or vinyl groups.

7. The method according to claim 5, wherein the curable composition has a viscosity of not less than 1 mPa·s and not more than 100 mPa·s at 23° C.

8. The method according to claim 5, wherein the composition obtained by removing the solvent from the curable composition has a viscosity of less than 1,000 mPa·s at 23° C.

9. The method according to claim 5, wherein a vapor pressure of the composition obtained by removing the solvent from the curable composition is not more than 0.001 mmHg at 80° C.

10. The method according to claim 5, wherein a lower limit of a molecular weight of a polymerizable functional group in the polymerizable compound is not less than 200.

11. A curable composition comprising:
not less than one type of polymerizable compound containing not less than one aromatic ring or aromatic heterocycle and not less than two vinyl groups directly combining with the aromatic ring or aromatic heterocycle;
a polymerization initiator; and
a solvent,
characterized in that a content of the solvent with respect to the whole curable composition is not less than 80 vol %.

12. The curable composition according to claim 11, wherein
the polymerizable compound is represented by one of 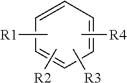
where R1 and R2 are vinyl groups or propenyl groups and R3 and R4 are hydrogen atoms or vinyl groups, 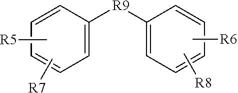
where R5 and R6 are vinyl groups or propenyl groups, R7 and R8 are hydrogen atoms or vinyl groups, and R9 is a single bond or a linear or oxygen atom or carbonyl group whose carbon number is 1 to 2, and 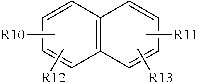
where R10 and R11 are vinyl groups or propenyl groups and R12 and R13 are hydrogen atoms or vinyl groups.

13. The curable composition according to claim 11, wherein the curable composition has a viscosity of not less than 1 mPa·s and not more than 100 mPa·s at 23° C.

14. The curable composition according to claim 11, wherein the composition obtained by removing the solvent from the curable composition has a viscosity of less than 1,000 mPa·s at 23° C.

15. The curable composition according to claim 11, wherein a vapor pressure of a composition obtained by removing the solvent from the curable composition is not more than 0.001 mmHg at 80° C.

16. The curable composition according to claim 11, wherein a lower limit of a molecular weight of a polymerizable functional group in the polymerizable compound is not less than 200.

17. A film forming method comprising:
arranging a curable composition defined in claim 11 on a substrate using a spin coating method; and
planarizing the curable composition arranged on the substrate to form a film.

18. An article manufacturing method comprising:
forming a film of a curable composition on a substrate using a film forming method defined in claim 1;
processing the substrate on which the film is formed in the forming; and
manufacturing an article from the substrate processed in the processing.

19. An article manufacturing method comprising:
forming a film of a curable composition on a substrate using a film forming method defined in claim 17;
processing the substrate on which the film is formed in the forming; and
manufacturing an article from the substrate processed in the processing.
